(19) United States
(12) Patent Application Publication
(10) Pub. No.: US 2022/0232799 A1
(43) Pub. Date: Jul. 28, 2022

(54) FEED DISPENSING ASSEMBLY

(71) Applicant: Donald Keith Newkirk, Sheridan, AR (US)

(72) Inventor: Donald Keith Newkirk, Sheridan, AR (US)

(21) Appl. No.: 17/155,344

(22) Filed: Jan. 22, 2021

(51) Int. Cl. A01K 5/02

(52) U.S. Cl. CPC A01K 5/0225

(57) ABSTRACT

A feed dispensing assembly that is capable of dispensing feed material (finely ground grain, powered grain, powdered peanut waste, or rice bran) and otherwise difficult to feed material in a reliable manner, where the feeder can be adjusted and adapted to dispense a wide variety of feed material, and where the feeder is physically operated by rotation of a container (such as enclosed cylinder) to dispense feed material. The container is physically rotated by various means, and openings in the walls of the container allow feed to exit to the target feeding surface at the feed location. The feed dispensing assembly can be incorporated into an existing feed trough or can be assembled as a standalone unit.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Many different types of feed materials that are used for animal consumption. The physical characteristics of feed material vary widely depending on the grain type and how fine the particle is ground. Ground grain/food powders are a diverse group of particulates. They vary considerably with respect to composition, size, potential to cake, along with the changing physical properties that stem from environmental conditions. Among these are cohesion and flowability as well as the tendency for the powder to segregate. And these characteristics are further impacted by the environmental conditions where they are stored. Humidity and ambient temperature can cause some feed materials to clump together and form a cake that is difficult to distribute resulting in batch dumping of the feed, or in some cases, the inability to dispense the feed altogether. Batch feeding requires repeated dumping of the feed material and can become wasteful due to weather conditions and feed location. And in cases where the feed isn't dispensing at all, the desired and intended feeding of animals isn't occurring.

There are currently several design mechanisms in use whereby feed material is distributed for animal consumption. A large portion of these feeders operate effectively in distributing whole grains and feed pellets that are free-flowing. In general, the free-flowing feed material is stored in a weatherproof/animal-proof container. On the bottom of the container a motor driven spinner plate is used to keep the feed in place. When a feed cycle is initiated the motor runs to distribute feed. This is caused by the spinner plate sweeping feed off the plate by blades or vanes on the plate. As the grain is distributed off the spinning plate it is replaced by grain in the container. Gravity and free-flowing characteristics of the grain enable the process. In some cases, attachments come up from the spinner plate and protrude into the feed container to help prevent grain plugging. These type feeders in general do not adapt well to light weight powdered feed material. There have been attempts to attach vibrating mechanisms or augers to better mix the feed material and allow for distribution with limited success.

Alternative designs utilize gravity alone to distribute feed material. These feeders are sometimes elevated with tubes open at the bottom. As the food is consumed gravity allows the feed material to descend into the feeding tubes. These tubes are generally positioned at a height for the desired animal that is to be fed. These feeders do not require any power to operate but also suffer from powdered feed material plugging the feeding openings.

Additional gravity bag feeders, vertical tube feeders, and box feeders with holding trays have been used with some success. This design utilizes a conical flexible bag or tube that houses the feed material. The opening of the vertical feeder is on the bottom and is suspended slightly above the ground. As the feed material is consumed it is replaced with feed that is stored in the housing/bag/tube.

Finally, bulk feed material dumping is another common dispensing practice. This is done by dumping feed material either into a trough with a roof on it or onto the ground. Dispensing feed material by this method requires frequent monitoring and repeated dumping of the material. In the practice of dumping the feed on the ground a considerable amount of feed can be wasted and spoiled before it is consumed. Non-target animals frequently consume the feed before the feed material is replenished.

While these various types of feed dispensing mechanism are available, and work well for some purposes, they are not ideal in many situations, particularly where the feed material used is powdered feed (such as finely ground grain, powdered grain, powdered peanut waste, or rice bran). What is needed is a feed dispensing assembly that efficiently and effectively dispenses feed material, and particularly powdered feed materials, in a reliable manner.

### BRIEF SUMMARY OF THE INVENTION

The present invention is generally directed to a feed dispensing assembly, particularly useful in the dispensing of powdered feed material. More particularly, the present invention is directed to a feed dispensing assembly that consists of a rotating container storing feed material above a feed location where feed material is desired to be dispensed. The rotation of the container continuously mixes and tumbles the feed material to prevent clumping and/or plugging, and openings in the walls of the container allow feed material to be dispensed from the container as the rotation occurs. The container can be rotated mechanically be a motor, which may be operated by a timer, to allow for feed dispensing as desired by the user. The feed dispensing assembly is capable of dispensing powdered feed materials that may otherwise be difficult to dispense from traditional feed dispensing technologies.

These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a side view of a feed dispensing assembly according to one embodiment of the present invention.

FIG. 2 is a front view of a feed dispensing assembly according to one embodiment of the present invention.

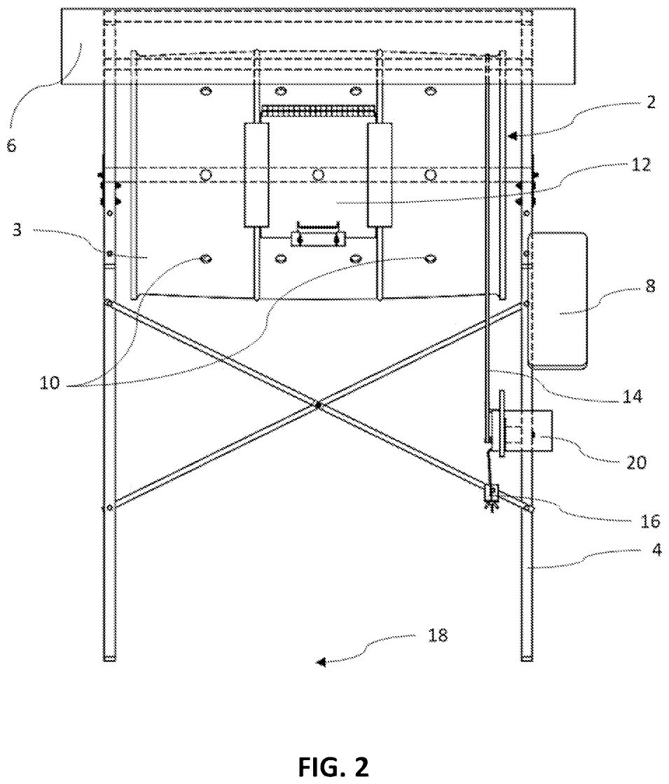

### DETAILED DESCRIPTION OF THE INVENTION

Generally speaking, the present invention is directed to a feed dispensing assembly, and more particularly, the present invention is directed to an assembly useful for dispensing feed material by way of a rotating container 2 of feed with openings 10 in the container 2 allowing feed material to be dispensed onto a feeding area 18 as the container 2 rotates. The rotation of the feed container 2 is effective to drastically reduce, or even eliminate, clumping of the feed, which traditionally has presented problems for feed dispensers utilizing powdered feed materials.

In the broadest terms, the feeding system of the present invention includes a rotating container 2 physically supported by a stand or frame 4 above a surface 18 where the feed is intended to be distributed. In the preferred embodiment, the container 2 is positioned such that the rotation occurs around a horizontal axis of the container 2 (such that the outer surface of the container 2 at the bottom position changes as the container 2 rotates). The feed material is loaded into the container 2 through a door 12 in the container 2, and is dispensed from the container 2 through openings 10 in the wall(s) of the container 2 as the container 2 rotates. This rotation of the container 2 also causes mixing and tumbling of the feed material inside the container 2 to prevent plugging of the openings 10 and ensure continuous distribution of the feed material onto the feeding surface 18. In one embodiment, the container 2 is rotated mechanically by a motor 20 that can be operated by a timer and power supply. It may be seen then, that the feeder assembly is particularly useful for dispensing powdered feed material that may otherwise be difficult to dispense using traditional feeding mechanisms.

The feed assembly of the present invention is intended to be positioned at a feed location 18, which refers to an area where the user desires to dispense feed or otherwise feed animals for any number of purposes. The most common example of a particularly useful scenario of use of the present invention is the use of the feed assembly to attract some sort of game animal to a feed location 18 for hunting purposes. Another likely scenario for use of the present invention would be for feeding livestock, which may be particularly suitable for larger scale embodiments of the invention. As noted, the present invention is useful for the dispensing of feed material for animal consumption at the feed location 18. Feed material that may be utilized with the feed dispensing assembly of the present invention includes any material edible by animals, including those that are typically used to attract animals to a feed location for trapping, hunting, herding, or other similar purposes. While a variety of feed material may be used with the present invention, it may be seen that the benefits of the present invention may be more fully realized with the use of powdered feed material or small-grain feed material, which may be easily and effectively dispensed from the openings 10 in the feed container 2, which are described more fully below. It may be seen, then, that the feed dispensing assembly of the present invention may present particular advantages over existing feed devices that tend to clog or plug when ground, powdered, or fine-grain feed material is used.

Having described the feed dispensing assembly of the present invention generally, the various components of the feed dispensing assembly in the preferred and various embodiments may now be described more fully. As noted, the feed dispensing assembly of the present invention includes a container 2 for storing the feed material, and, as noted, for dispensing the feed material during rotation. The container 2 generally has external walls 3 that join together to create an internal compartment where the feed material is stored. While the container 2 can take any number of shapes, in the preferred embodiment the container is a cylindrical drum (which will allow for more efficient dispensing of feed material during rotation of the container 2). In order to avoid the destruction of the container 2 by animals and to avoid the access of the internal feed material by animals, the container 2 is preferably made of a strong and durable material. This will also help keep the feed material dry or otherwise in a good, edible condition for dispensing and for animal consumption. Suitable materials may be hard plastic materials, metals, other similar materials.

As noted, the feed stored in the container 2 is intended to be used for animal consumption. But, as noted, the container 2 is preferably animal-proof to keep animals from accessing the stored feed material. Thus, in order to facilitate the feeding of animals at the feed location, the present invention must contain some mechanism for dispensing the stored feed material from the internal compartment of the container 2 to a position 18 outside of the container 2 so that is accessible by the animals for consumption. In this regard, the external walls 3 of the container 2 include a number of dispensing openings 10 through the walls 3 that allow for the dispensing of the stored feed material from the container 2, which is facilitated through the rotation of the container 2 along a horizontal axis. The container 2 is positioned a distance from the ground or other feed surface 18 such that the feed material falls from bottom openings 10 in the container 2 due to gravity. It should be noted, of course, that where openings 10 are positioned at various points around the perimeter of the container's walls 3, at a given point, its likely that only a portion of the openings 10 will be at the bottom of the container 2 at that point (and those openings 10 will change as the container 2 rotates, so that different openings 10 act as the bottom, dispensing openings 10 in a rotating manner). Thus, the feed material will primarily be dispensed from those particular openings 10 at that point.

As the container 2 rotates, feed material will be dispensed from the openings 10 around the container 2 in a rotating manner as the openings 10 move to the bottom position. This facilitates feed dispensing and helps prevent the clogging of any particular opening 10, as the feed material will tumble and mix inside the container 2 as rotation of the container occurs. It should be noted that the number and position of openings 10 may be modified as desired, and it may be seen that a portion of the container walls 3 may not have any openings 10 such that, if desired, the user can rotate the container 2 such that this completely solid section of container wall 3 is positioned on the bottom so that no feed material is dispensed at that position. It should also be noted that the size and/or shape of the openings 10 can be modified as desired to allow for different amounts of feed material dispensing (where more material will dispense/fall from a larger opening 10 and less material will dispense/fall from smaller openings 10).

While these openings 10 in the container 2 are primarily useful for dispensing the feed, another opening in the container 2, a loading opening or door 12, is not particularly configured for dispensing feed, but instead, is operable to allow the user to load and reload the container 2 with feed material as desired. Of course, the container 2 will need to be loaded a first time with feed material in order to begin feed dispensing, and in order to maintain feed dispensing over a period of time, it may be necessary to add additional feed material to the container as the existing feed material is dispensed through the dispensing openings 10. In one embodiment the loading opening 12 may be a hinged door, but other various embodiments may also be used so long as the loading opening 12 is sufficiently large to allow the user to sufficiently load feed material into the container 2. Some sort of closing component and locking mechanism allowing the user to close the loading opening 12 and prevent the loading opening 12 from inadvertently opening during the rotation process may be included to ensure that feed is not unintentionally dispensed from the larger loading opening 12 during operation.

While it is understood that the rotation of the container 2 can be facilitated by the user manually by physical rotation of the container 2, in the preferred embodiment, the feed dispensing assembly of the present invention includes a motor 20 operable to mechanically rotate the container 2. In one embodiment, the motor 20 may be in communication with a timer such that the motor 20 is activated periodically to rotate the container 2, which may, for example, be at a predetermined time or series of predetermined times identified by the user. In an alternative embodiment, it may be seen that the motor 20 can be remotely activated by the user through some wireless communications means such that the user can actively and selectively determine the proper time for rotation of the container 2. The motor 20 may be battery operable (by, for example, rechargeable batteries), or may, for example, be charged via solar power so that the assembly can be placed in a remote location without the need for constant changing of battery. Other power sources can be used as desired. The electrical components, such as the battery, timer, or other similar components is preferably stored in a watertight storage box 8 connected to the frame 4 to prevent damage to such components.

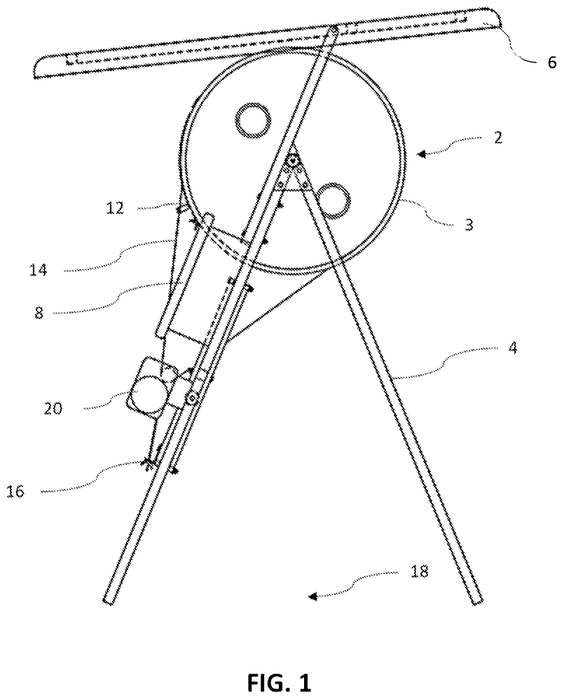

To most effectively facilitate the dispensing of the feed material from the openings 10 of the container 2, the container 2 of the present invention should be positioned at some height above the feed location 18 to allow the feed material to fall from the openings 10 of the container 2 due to gravity (as discussed more fully above). In this regard, the container 2 can be mounted on a structure at a height above the feed location 18. In the preferred embodiment, the container 2 is mounted on a frame or stand that 4 raises the container 2 a distance from the ground or other surface at the feed location 18. In one embodiment, the frame 4 may generally be described as an A-frame, with two legs arranged in an angle attached at the top to the container's 2 axis of rotation, as shown for example in FIG. 1. To withstand any movement by the animals, a durable material such as galvanized steel is preferably used for the frame 4. Alternatively, the container 2 may be mounted into existing elevated trough feeders that are weather protected. In any event, mounting the container 2 not only helps facilitated dispensing due to gravity, but also serves to keep the container 2 inaccessible to larger animals (such as hogs) that may otherwise be able to access the feed material even in the most durable of containers 2.

In one embodiment the frame 4 of the feed dispensing assembly may further include a roof or hood. 6 This roof or hood 6 is intended to cover the container 2 of the feed dispensing assembly in order to keep the container 2 sheltered from the rain, and thus to keep the feed material dry. Likewise, the hood/roof 6 can be beneficial from keeping other contaminants from entering the openings 10 in the feed container 2. The maintaining of good feed material condition combined with a reliable dispensing mechanism provides a consistent feeding cycle of a material that would otherwise be hard to utilize for animal feed.

Having described the various embodiments of the feed dispensing assembly of the present invention, one very specific example of the specifications and parameters of the invention may be provided. In one embodiment, for example, the feed container 2 may be a cylindrical drum in the form of a 55-gallon drum, which would provide the capacity to hold approximately 200-250 pounds of feed material. Around the container 2 may be positioned a number of 1-inch diameter openings 10 for dispensing the feed material, and a hinged door 12 may be used as the loading opening 12 to allow the user to load and reload feed into the container 2. A motor 20 and timer may operate to facilitate the rotation of the cylindrical drum container 2, and these components may be housed in a water proof housing 8 to protect the mechanical and electrical components. In addition, a non-slipping reinforced rubber belt 14 and an adjustable belt tensioner 16 may be utilized to facilitate the rotation of the container 2. A hood 6 is positioned above the cylindrical drum container 2 to protect the container 2 and feed stored therein from external elements such as rain. Of course, while this is one specific example embodiment of the feed dispensing assembly, this same basic design can be scaled up considerably to handle several thousand pounds of feed material for larger operations by using a larger drum container 2 or by otherwise modifying the shape and/or size of the container 2. There is versatility in the type of feed material that can be handled by this unit due to the easily adjustable drum size openings and orientation.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A feed dispensing assembly comprising:
a. a rotatable feed storage container comprising an internal compartment for storing feed material;
b. a number of dispensing openings in the storage container configured to dispense feed material from the storage container;
wherein the feed storage container is positioned at a height above a feed surface; and
wherein upon rotation of the feed storage container, feed material is dispensed from the storage container onto the feed surface.

2. The feed dispensing assembly of claim 1, further comprising a motor operable to facilitate rotation of the feed storage container.

3. The feed dispensing assembly of claim 2, further comprising a timer in communication with the motor, wherein the timer is operable to selectively power the motor at periodic intervals to facilitate rotation of the feed storage container at the periodic intervals.

4. The feed dispensing assembly of claim 1, further comprising a frame for holding the feed storage container at the height above the feed surface.

5. The feed dispensing assembly of claim 1, further comprising a roof operable to cover the feed storage container.

6. The feed dispensing assembly of claim 1, further comprising a loading opening in the feed storage container operable to facilitate loading and reloading of feed material into the internal compartment of the feed storage container.

7. The feed dispensing assembly of claim 1, wherein the feed storage container is a cylindrical drum.

8. The feed dispensing assembly of claim 1, wherein the feed material is ground feed material.

9. The feed dispensing assembly of claim 1, wherein the feed material is a powder feed material.

10. A feed dispensing assembly comprising:
a. a feed storage container configured to be positioned a distance above a feeding surface; and
b. a number of feed dispensing openings in the feed material storage container;
wherein the feed storage container is configured to rotate about a horizontal axis, whereby rotation of the feed storage container causes feed material to be dispensed from at least a portion of the number of feed dispensing openings.

11. The feed dispensing assembly of claim 10, further comprising a motor operable to facilitate rotation of the feed storage container.

12. The feed dispensing assembly of claim 11, further comprising a timer operable to selectively power the motor at periodic intervals to facilitate rotation of the feed storage container at the periodic intervals.

13. The feed dispensing assembly of claim 10, further comprising a frame for holding the feed storage container at the distance above the feed surface.

14. The feed dispensing assembly of claim 10, further comprising a roof operable to cover the feed storage container.

15. The feed dispensing assembly of claim 10, further comprising a loading opening in the feed storage container operable to facilitate loading and reloading of feed material into the feed storage container.

16. The feed dispensing assembly of claim 10, wherein the feed storage container is a cylindrical drum.

17. The feed dispensing assembly of claim 10, wherein the feed material is ground feed material.

18. The feed dispensing assembly of claim 10, wherein the feed material is a powder feed material.
